(19) United States
(12) Patent Application Publication
(10) Pub. No.: US 2026/0153224 A1
(43) Pub. Date: Jun. 4, 2026

(54) LIGHT-EMITTING MODULE AND LAMP PANEL STRUCTURE INCLUDING THE SAME

(71) Applicant: Lextar Electronics Corporation, Hsinchu City (TW)

(72) Inventor: Hsin-Jung TSAI, Hsinchu City (TW)

(21) Appl. No.: 19/178,657

(22) Filed: Apr. 14, 2025

(30) Foreign Application Priority Data
Apr. 15, 2024 (TW) 113113905

(51) Int. Cl. F21V 13/04; F21V 5/04; F21Y 105/16

(52) U.S. Cl. CPC F21V 13/04; F21V 5/04; F21Y 2105/16

(57) ABSTRACT

A light-emitting module is provided. The light-emitting module includes a light source and a lens structure disposed on the light source. The lens structure has a first surface and a second surface. The second surface is opposite to the first surface and adjacent to the light source. The first surface includes a first recessed portion and a plurality of second recessed portions. The first recessed portion corresponds to the light source. The second recessed portions are located in the extending direction of the first recessed portion. The second surface has a reflective surface located between the first recessed portion and the second recessed portions.

### CROSS REFERENCE TO RELATED APPLICATIONS

This Application claims priority of Taiwan Patent Application No. 113113905, filed on Apr. 15, 2024, the entirety of which is incorporated by reference herein.

### TECHNICAL FIELD

The disclosure relates to a light-emitting module and a lamp panel structure including the same, and in particular, they relate to a light-emitting module with a specific lens structure and a lamp panel structure including the light-emitting module.

### BACKGROUND

### Description of the Related Art

Currently, the light sources used in direct-lit models on the market are arranged in a matrix. Due to problems with the light-emission angle of the light source (for example, there may be an insufficient light-expansion angle), the light sources need to be arranged very densely, and a larger number of light sources need to be used to achieve a uniform effect within the light-emitting surface, resulting in increased costs.

### SUMMARY

An embodiment of the present disclosure provides a light-emitting module. The light-emitting module includes a light source and a lens structure. The lens structure is disposed on the light source. The lens structure has a first surface and a second surface. The second surface is opposite the first surface and adjacent to the light source. The first surface comprises a first recessed portion and a plurality of second recessed portions. The first recessed portion corresponds to the light source. The second recessed portions are located in the extending direction of the first recessed portion. The second surface has a reflective surface located between the first recessed portion and the second recessed portions.

In the light-emitting module of the present disclosure, after the light emitted by the light source passes through the reflective structure (for example, the first recessed portion) in the lens structure, part of the light will move around, and then the light can be emitted out from a predetermined location (for example, the second recessed portion) by the bottom design (for example, the reflective surface) of the lens structure. The present disclosure utilizes a design with a single light source with a specific lens structure (for example, a single light source with a lens structure having four second recessed portions) to achieve the luminous effect of five light sources, effectively reducing the number of required light sources.

In some embodiments, a lamp panel structure is provided. The lamp panel structure includes a printed circuit board (PCB) and a plurality of light-emitting modules. The light-emitting modules are disposed on the printed circuit board (PCB). The light-emitting modules comprise a plurality of first light-emitting modules and a plurality of second light-emitting modules. The first light-emitting modules are disposed on the printed circuit board (PCB) along a first direction. The second light-emitting modules are disposed on the printed circuit board (PCB) along a second direction. An angle between the first direction and the second direction is 45 degrees. The first light-emitting modules and the second light-emitting modules are arranged in an alternating manner respectively along a third direction and a fourth direction. The third direction is perpendicular to the fourth direction, and the first direction is parallel to the third direction.

In some embodiments, a lamp panel structure is provided. A lamp panel structure includes a printed circuit board (PCB) and a plurality of light-emitting modules. The light-emitting modules are disposed on the printed circuit board (PCB). The light-emitting modules are arranged in a staggered manner respectively along a first direction and a second direction, and the first direction is perpendicular to the second direction.

The light-emitting module of the present disclosure can be applied in various electronic devices. In order to make the features and advantages of the present disclosure more readily be understood, various embodiments are given in the subsequent description in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Aspects of the present disclosure are better understood from the following detailed description when read with the accompanying figures. It is worth noting that some features may not be drawn to scale in accordance with the standard practice in the industry. In fact, the dimensions of the various features may be arbitrarily increased or reduced for clarity of discussion.

FIG. 1 illustrates a cross-sectional view of a light-emitting module according to one embodiment of the present disclosure.

FIG. 2A illustrates a cross-sectional view of a light-emitting manner of a light source according to one embodiment of the present disclosure.

FIG. 2B illustrates a cross-sectional view of a light-emitting manner of a light source according to one embodiment of the present disclosure.

FIG. 2C illustrates a cross-sectional view of a light-emitting manner of a light source according to one embodiment of the present disclosure.

FIG. 2D illustrates a cross-sectional view of a light-emitting manner of a light source according to one embodiment of the present disclosure.

FIG. 2E illustrates a cross-sectional view of a light-emitting manner of a light source according to one embodiment of the present disclosure.

FIG. 3 illustrates a stereo view of a lens structure according to one embodiment of the present disclosure.

FIG. 4 illustrates a cross-sectional view of a second recessed portion of a lens structure according to one embodiment of the present disclosure.

FIG. 5 illustrates a cross-sectional view of a second recessed portion of a lens structure according to one embodiment of the present disclosure.

FIG. 6A illustrates a schematic diagram of a microstructure according to one embodiment of the present disclosure.

FIG. 6B illustrates a schematic diagram of a microstructure according to one embodiment of the present disclosure.

FIG. 6C illustrates a schematic diagram of a microstructure according to one embodiment of the present disclosure.

FIG. 6D illustrates a schematic diagram of a microstructure according to one embodiment of the present disclosure.

FIG. 7 illustrates a cross-sectional view of a light-emitting module according to one embodiment of the present disclosure.

FIG. 8 illustrates a top view of a lamp panel structure according to one embodiment of the present disclosure.

FIG. 9 illustrates a top view of a lamp panel structure according to one embodiment of the present disclosure.

FIG. 10 illustrates a traveling path of light in a lens structure according to one embodiment of the present disclosure.

FIG. 11A illustrates a visual effect test of a single single-sided-luminescence light source with the disclosed lens structure according to one embodiment of the present disclosure.

FIG. 11B illustrates a visual effect test of a light-emitting module composed of single-sided-luminescence light source without the disclosed lens structure according to one embodiment of the present disclosure.

FIG. 11C illustrates a visual effect test of a light-emitting module composed of single-sided-luminescence light source with the disclosed lens structure according to one embodiment of the present disclosure.

FIG. 12 illustrates a traveling path of light in a lens structure according to one embodiment of the present disclosure.

FIG. 13A illustrates a visual effect test of a single multiple-sided-luminescence light source with the disclosed lens structure according to one embodiment of the present disclosure.

FIG. 13B illustrates a visual effect test of a light-emitting module composed of multiple-sided-luminescence light source without the disclosed lens structure according to one embodiment of the present disclosure.

FIG. 13C illustrates a visual effect test of a light-emitting module composed of multiple-sided-luminescence light source with the disclosed lens structure according to one embodiment of the present disclosure.

### DETAILED DESCRIPTION

The light-emitting module of the present disclosure is described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. In addition, in this specification, expressions such as “first material layer disposed on/over a second material layer”, may indicate the direct contact of the first material layer and the second material layer, or it may indicate a non-contact state with one or more intermediate layers between the first material layer and the second material layer. In the above situation, the first material layer may not be in direct contact with the second material layer.

In addition, in this specification, relative expressions are used. For example, “lower”, “bottom”, “higher” or “top” are used to describe the position of one element relative to another. It should be appreciated that if a device is flipped upside down, an element that is “lower” will become an element that is “higher”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In the description, relative terms such as “lower”, “upper”, “horizontal”, “vertical”, “above”, “below”, “up”, “down”, “top” and “bottom” as well as derivative thereof (e.g., “horizontally”, “downwardly”, “upwardly”, etc.) should be construed as referring to the orientation as described or as shown in the drawing under discussion. These relative terms are for convenience of description and do not require that the apparatus be constructed or operated in a particular orientation. Terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section discussed below could be termed a second element, component, region, layer, portion or section without departing from the teachings of the present disclosure.

Herein, the terms “about”, “around” and “substantially” typically mean +/−20% of the stated value or range, typically +/−10% of the stated value or range, typically +/−5% of the stated value or range, typically +/−3% of the stated value or range, typically +/−2% of the stated value or range, typically +/−1% of the stated value or range, and typically +/−0.5% of the stated value or range. The stated value of the present disclosure is an approximate value. Namely, the meaning of “about”, “around” and “substantially” may be implied if there is no specific description of “about”, “around” and “substantially”.

The following description is of the best-contemplated mode of carrying out the disclosure. This description is made for the purpose of illustrating the general principles of the disclosure and should not be taken in a limiting sense. The scope of the disclosure is best determined by reference to the appended claims.

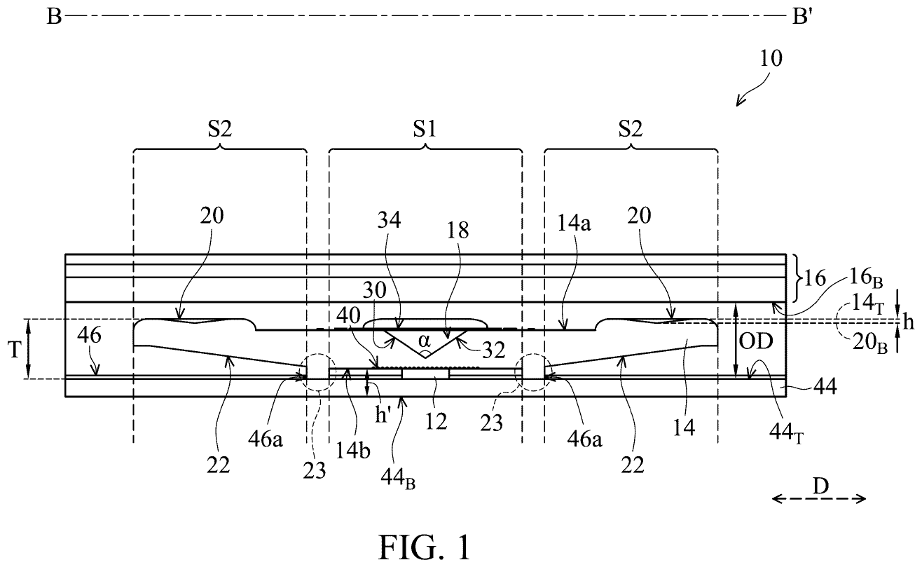

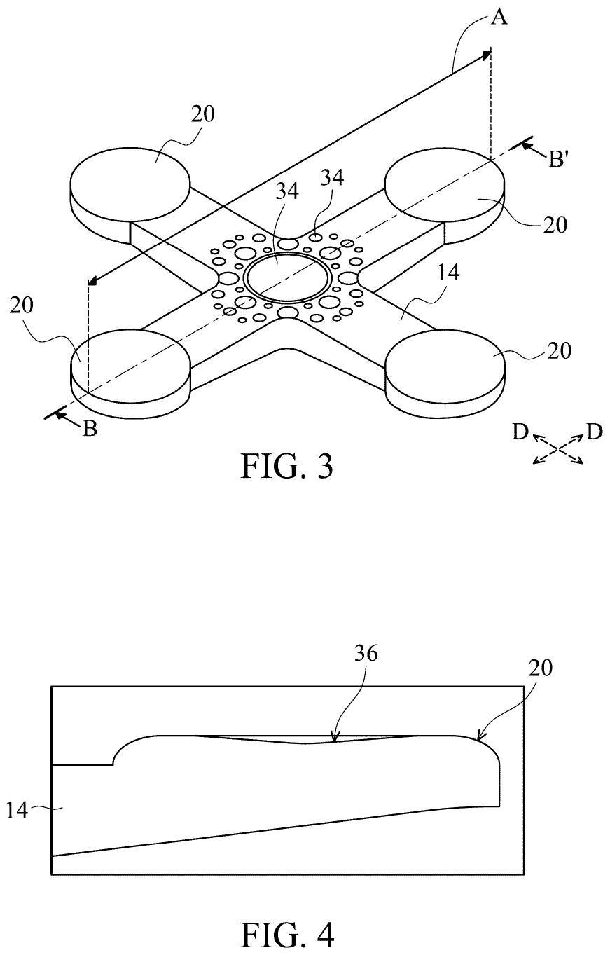

Referring to FIG. 1, according to one embodiment of the present disclosure, a light-emitting module 10 is provided. FIG. 1 illustrates a cross-sectional view of the light-emitting module 10 obtained along a cross-sectional line B-B′ of FIG. 3.

As shown in FIG. 1, the light-emitting module 10 includes a light source 12, a lens structure 14, and an optical component set 16. The lens structure 14 is disposed on the light source 12. The optical component set 16 is disposed on the lens structure 14. The lens structure 14 has a first surface 14a and a second surface 14b. The second surface 14b is opposite to the first surface 14a and adjacent to the light source 12. The first surface 14a includes a first recessed portion 18 and a plurality of second recessed portions 20. The first recessed portion 18 corresponds to the light source 12. The second recessed portions 20 are located in the extending direction D of the first recessed portion 18. The second surface 14b has a reflective surface 22 located between the first recessed portion 18 and the second recessed portions 20. In some embodiments, the lens structure 14 has a supporting portion 23. In some embodiments, the number of the supporting portions 23 is 3 to 8.

In some embodiments, the height difference h between the lowest point 20_{B} of the second recessed portion 20 and the highest point 14_{T} of the lens structure 14 is between approximately 0.01 mm and approximately 1 mm. In some embodiments, the height difference h between the lowest point 20_{B} of the second recessed portion 20 and the highest point 14_{T} of the lens structure 14 may be 0.01 mm, 0.1 mm, 0.2 mm, 0.3 mm, 0.4 mm, 0.5 mm, 0.6 mm, 0.7 mm, 0.8 mm, 0.9 mm, or 1 mm.

In some embodiments, the second surface 14b may be a flat surface, a curved surface, an inclined surface, or a combination thereof. In some embodiments, the second surface 14b may be a combination of a flat surface and a curved surface. In some embodiments, the second surface 14b may be a combination of a flat surface and an inclined surface.

In some embodiments, the light source 12 may include a light-emitting diode or a sub-millimeter light-emitting diode (mini LED), but the present disclosure is not limited thereto, and other suitable light sources may also be applicable to the present disclosure. In some embodiments, the light source 12 may emit white light, blue light, or ultraviolet light, but the present disclosure is not limited thereto. The light source 12 may also emit light of other wavelengths, such as red light or green light.

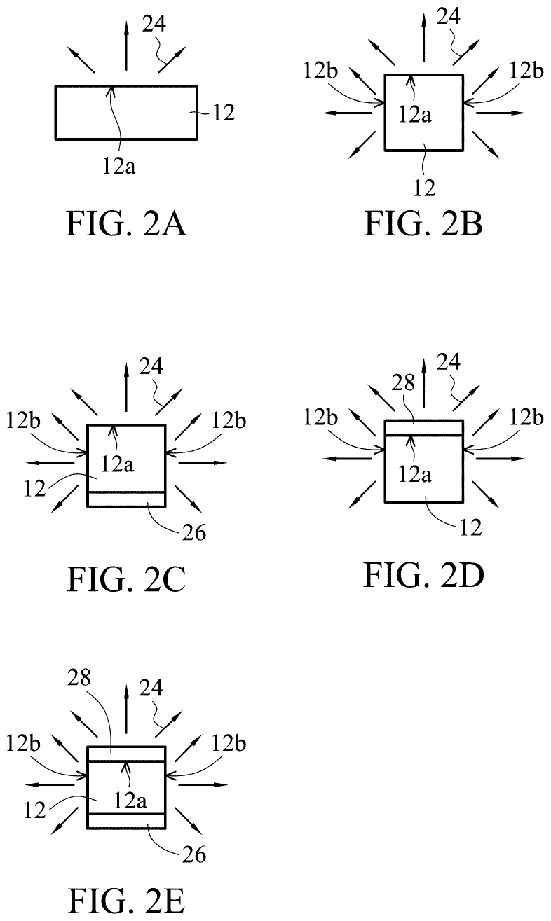

Referring to FIGS. 2A-2E, the light-emitting manners of the light source 12 are further illustrated. FIGS. 2A-2E illustrate cross-sectional views of the light-emitting manners of the light source 12.

As shown in FIG. 2A, the light source 12 (for example, a cube structure) emits light from one side. For example, the light-emitting surface is the upper surface 12a of the light source 12. In some embodiments, the light 24 is emitted from the upper surface 12a of the light source 12 towards the surroundings, forming a single-sided luminescence. In some embodiments, the light source 12 may be a light-emitting diode package with a reflective cup.

As shown in FIG. 2B, the light source 12 (for example, a cube structure) emits light from multiple sides, for example, from five sides. For example, the light-emitting surface includes the upper surface 12a and the four side surfaces 12b of the light source 12. In some embodiments, the light 24 is emitted from the upper surface 12a and the four side surfaces 12b of the light source 12 towards the surroundings, forming a five-sided luminescence.

As shown in FIG. 2C, the light source 12 (for example, a cube structure) is further disposed on a substrate 26. The light source 12 emits light from multiple sides, for example, from five sides. For example, the light-emitting surface includes the upper surface 12a and the four side surfaces 12b of the light source 12. In some embodiments, the light 24 is emitted from the upper surface 12a and the four side surfaces 12b of the light source 12 towards the surroundings, forming a five-sided luminescence.

As shown in FIG. 2D, a reflective layer 28 is further disposed on the upper surface 12a of the light source 12 (for example, a cube structure). The light source 12 emits light from multiple sides, for example, from four sides. For example, the light-emitting surface includes the four side surfaces 12b of the light source 12. In some embodiments, the light 24 is emitted from the four side surfaces 12b of the light source 12 towards the surroundings, forming a four-sided luminescence. Since the upper surface 12a of the light source 12 is provided with the reflective layer 28, the intensity of the light 24 emitted from the four side surfaces 12b can be enhanced. In some embodiments, the reflective layer 28 may be a distributed Bragg reflector (DBR).

As shown in FIG. 2E, a reflective layer 28 is further disposed on the upper surface 12a of the light source 12 (for example, a cube structure), and the light source 12 is further disposed on a substrate 26. The light source 12 emits light from multiple sides, for example, from four sides. For example, the light-emitting surface includes the four side surfaces 12b of the light source 12. In some embodiments, the light 24 is emitted from the four side surfaces 12b of the light source 12 towards the surroundings, forming a four-sided luminescence. Since the upper surface 12a of the light source 12 is provided with the reflective layer 28, the intensity of the light 24 emitted from the four side surfaces 12b can be enhanced.

In some embodiments, the first recessed portion 18 of the lens structure 14 may include a V-shaped recessed portion, as shown in FIG. 1. In some embodiments, when the first recessed portion 18 is a V-shaped recessed portion, the first recessed portion 18 includes a first reflective surface 30 and a second reflective surface 32. The angle α between the first reflective surface 30 and the second reflective surface 32 is between approximately 85 degrees and approximately 130 degrees, so as to reflect the light emitted from the light source 12. In some embodiments, the angle α between the first reflective surface 30 and the second reflective surface 32 may be 85 degrees, 90 degrees, 95 degrees, 100 degrees, 105 degrees, 115 degrees, 120 degrees, 125 degrees, or 130 degrees.

In some embodiments, the light-emitting module 10 further includes a reflective layer 34 disposed on the first recessed portion 18. In some embodiments, the thickness of the reflective layer 34 is between approximately 0.01 mm and approximately 0.5 mm.

Referring to FIG. 3, the configuration of the reflective layer 34 is further illustrated. FIG. 3 illustrates a stereo view of the lens structure 14.

As shown in FIG. 3, the lens structure 14 includes the first recessed portion 18 (located inside the lens structure 14, referring to FIG. 1) and a plurality of second recessed portions 20. The second recessed portions 20 are located in the extending direction D of the first recessed portion 18. In FIG. 3, parameter A represents the maximum length of the lens structure 14. The extending direction D refers to the direction along the measurement of parameter A. The reflective layer 34 is disposed on the first recessed portion 18. In some embodiments, as shown in FIG. 3, the reflective layer 34 may include multiple pieces of circular reflective materials with different sizes, and may be distributed on the lens structure 14 in a specific manner according to product requirements. In some embodiments, the reflective layer 34 completely covers the first recessed portion 18. In some embodiments, the reflective layer 34 may be distributed in regular dots on the lens structure 14. In some embodiments, the reflective layer 34 may be distributed in irregular dots on the lens structure 14.

In some embodiments, the number of the second recessed portions 20 of the lens structure 14 may include two, three, or four. For example, the lens structure 14 has four second recessed portions 20, as shown in FIG. 3. It is worth noting that each second recessed portion 20 can serve as a light-emitting surface of the lens structure 14.

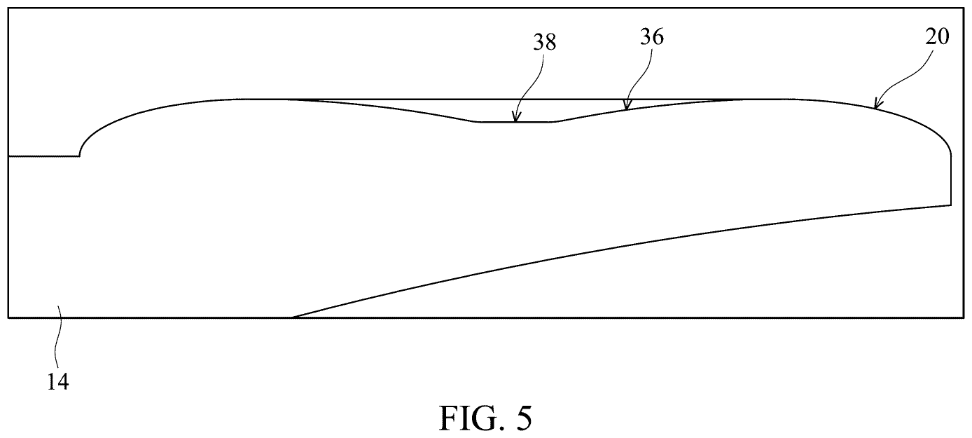

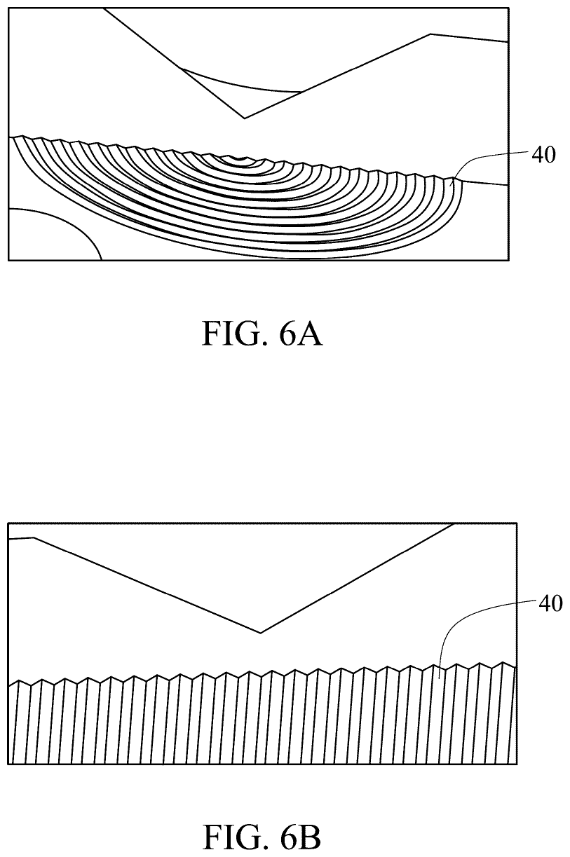

Referring to FIGS. 4 and 5, the structural features of the second recessed portion 20 are further described. FIGS. 4 and 5 illustrate cross-sectional views of the second recessed portion 20.

As shown in FIG. 4, each second recessed portion 20 may include a curved surface 36, that is, the lens structure 14 has multiple curved light-emitting surfaces, which can achieve the effect of multiple light source dots.

As shown in FIG. 5, the center of the curved surface 36 of the second recessed portion 20 may further include a flat surface 38, which can further enhance the light-gathering effect of the lens structure 14 at the second recessed portion 20.

Referring to FIG. 1, the second surface 14b of the lens structure 14 includes a first area S1 and a second area S2. The first area S1 corresponds to the light source 12. The second area S2 includes the reflective surface 22 and is adjacent to the first area S1. In some embodiments, the first area S1 may include a flat surface, an inclined surface, or a combination thereof. In some embodiments, the second area S2 may include an inclined surface, a curved surface, or a combination thereof.

In some embodiments, the light-emitting module 10 further includes a microstructure 40 disposed on the first area S1 of the second surface 14b, corresponding to the light source 12.

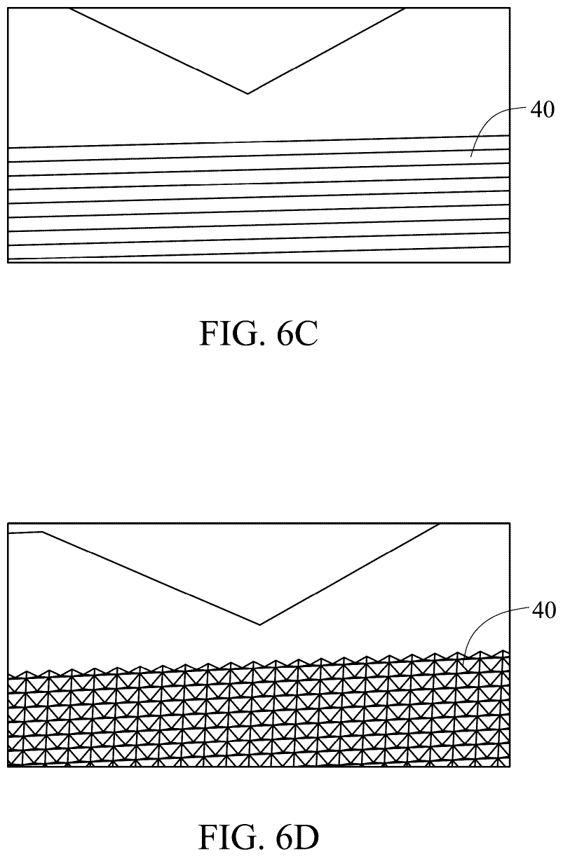

Referring to FIGS. 6A to 6D, the configuration of the microstructure 40 is further illustrated. FIGS. 6A to 6D illustrate schematic diagrams of the microstructure 40.

As shown in FIG. 6A, the microstructure 40 includes a plurality of V-shaped structures arranged in a circular pattern.

As shown in FIG. 6B, the microstructure 40 includes a plurality of V-shaped structures arranged in a longitudinal pattern.

As shown in FIG. 6C, the microstructure 40 includes a plurality of V-shaped structures arranged in a transverse pattern.

As shown in FIG. 6D, the microstructure 40 includes a plurality of V-shaped structures arranged in a horizontally and vertically overlapping pattern.

In some embodiments, the height of the microstructure 40 is between approximately 0.001 mm and approximately 0.2 mm. In some embodiments, the distance between the V-shaped structures in the microstructure 40 is equidistant. In some embodiments, the distance between the V-shaped structures in the microstructure 40 is between approximately 0.01 mm and approximately 0.1 mm.

In some embodiments, the thickness T of the lens structure 14 is between approximately 2 mm and approximately 8 mm. In some embodiments, the thickness T of the lens structure 14 may be 5 mm.

In some embodiments, the optical component set 16 may include, for example, a diffusion plate, a quantum-dot film, a structural film, and a liquid-crystal screen, but the present disclosure is not limited thereto. Other suitable optical components may also be included in the present disclosure, such as a brightness enhancement film (BEF).

In some embodiments, the material of the diffusion plate may include polystyrene (PS), polycarbonate (PC), polyethylene (PE), polypropylene (PP), polyvinyl chloride (PVC), polyethylene terephthalate (PET), polymethyl methacrylate (PMMA), or methyl methacrylate (MMA), but the present disclosure is not limited thereto, and other suitable light-transmissive polymeric materials or synthetic materials may also be applicable to the present disclosure.

In some embodiments, the material of the quantum-dot film may include cadmium sulfide (CdS), cadmium selenide (CdSe), or cadmium telluride (CdTe), but the present disclosure is not limited thereto. Other suitable nanoscale semiconductor particles or crystals that can perform wavelength conversion may also be applicable to the present disclosure.

In some embodiments, the light-emitting module 10 is further disposed on a printed circuit board (PCB) 44. In some embodiments, a reflective sheet 46 is further disposed on the printed circuit board (PCB) 44. The reflective sheet 46 has foot (i.e. the supporting portion) openings 46a therein for the lens structure 14 to be disposed on the printed circuit board (PCB) 44.

In some embodiments, the present disclosure can be used for a backlight module with an optical distance (OD) of 4 or more. The optical distance (OD) is the distance from the bottom 16_{B} of the optical component set 16 to the top surface 44_{T} of the printed circuit board (PCB) 44.

In some embodiments, the distance h′ from the second surface 14b in the first area S1 to the bottom surface 44_{B} of the printed circuit board (PCB) 44 is between approximately 0.1 mm and approximately 1 mm. Therefore, the light source 12, for example, a light-emitting diode package with a reflective cup, can be placed without affecting the flatness when mounting the lens structure 14.

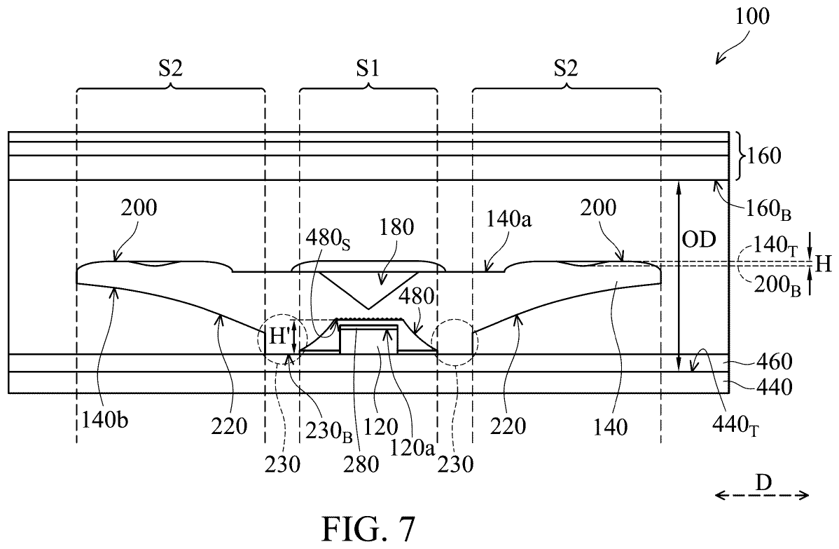

Referring to FIG. 7, according to one embodiment of the present disclosure, a light-emitting module 100 is provided. FIG. 7 illustrates a cross-sectional view of the light-emitting module 100.

As shown in FIG. 7, the light-emitting module 100 includes a light source 120, a lens structure 140, and an optical component set 160. The lens structure 140 is disposed on the light source 120. The optical component set 160 is disposed on the lens structure 140. The lens structure 140 has a first surface 140a and a second surface 140b. The second surface 140b is opposite to the first surface 140a and adjacent to the light source 120. The first surface 140a includes a first recessed portion 180 and a plurality of second recessed portions 200. The first recessed portion 180 corresponds to the light source 120. The second recessed portions 200 are located in the extending direction D of the first recessed portion 180. In FIG. 3, parameter A represents the maximum length of the lens structure 14. The extending direction D refers to the direction along the measurement of parameter A. The second surface 140b has a reflective surface 220 located between the first recessed portion 180 and the second recessed portions 200. In addition, the second surface 140b of the lens structure 140 includes a first area S1 and a second area S2. The first area S1 corresponds to the light source 120. The second area S2 includes the reflective surface 220 and is adjacent to the first area S1. In some embodiments, the lens structure 140 has a supporting portion 230. In some embodiments, the number of the supporting portions 230 is 3 to 8.

In some embodiments, the first surface 140a may be a matte surface or a glossy surface.

In some embodiments, the slope of the second surface 140b decreases with increasing height (the distance from the printed circuit board (PCB) 440).

The height difference H between the lowest point 200_{B} of the second recessed portion 200 and the highest point 140_{T} of the lens structure 140 is between approximately 0.01 mm and approximately 1 mm.

In FIG. 7, the portions similar to those in FIG. 1 will not be described again here. The main difference from FIG. 1 is that the first area S1 of the second surface 140b of the lens structure 140 of the light-emitting module 100 disclosed in FIG. 7 further includes a third recessed portion 480 formed to surround the light source 120. In some embodiments, the top portion of the lens structure 140 disclosed in FIG. 7 may not include the reflective layer 34 as shown in FIG. 1.

In some embodiments, the third recessed portion 480 has a flat surface, a curved surface, an inclined surface, or a combination thereof. In some embodiments, the third recessed portion 480 has a flat surface and a curved surface to form a space for accommodating the light source 120. In some embodiments, the third recessed portion 480 has a flat surface and an inclined surface to form a space for accommodating the light source 120. In some embodiments, the flat surface of the third recessed portion 480 is a light-incident surface 480_{S}. The distance H′ between the light-incident surface 480_{S} of the third recessed portion 480 and the bottom 230_{B} of the supporting portion 230 of the lens structure 140 is between approximately 0.2 mm and approximately 3 mm.

In some embodiments, the upper surface 120a of the light source 120 is provided with a reflective layer 280. In some embodiments, the reflective layer 280 may be a distributed Bragg reflector (DBR).

In some embodiments, the lens structure 140 may be a symmetrical structure centered on the first recessed portion 180.

In some embodiments, the light-emitting module 100 is further disposed on a printed circuit board (PCB) 440. In some embodiments, a reflective sheet 460 is further disposed between the printed circuit board (PCB) 440 and the lens structure 140.

In some embodiments, the present disclosure can be used for a backlight module with an optical distance (OD) of 4 or more. The optical distance (OD) is the distance from the bottom 160_{B} of the optical component set 160 to the top surface 440_{T} of the printed circuit board (PCB) 440.

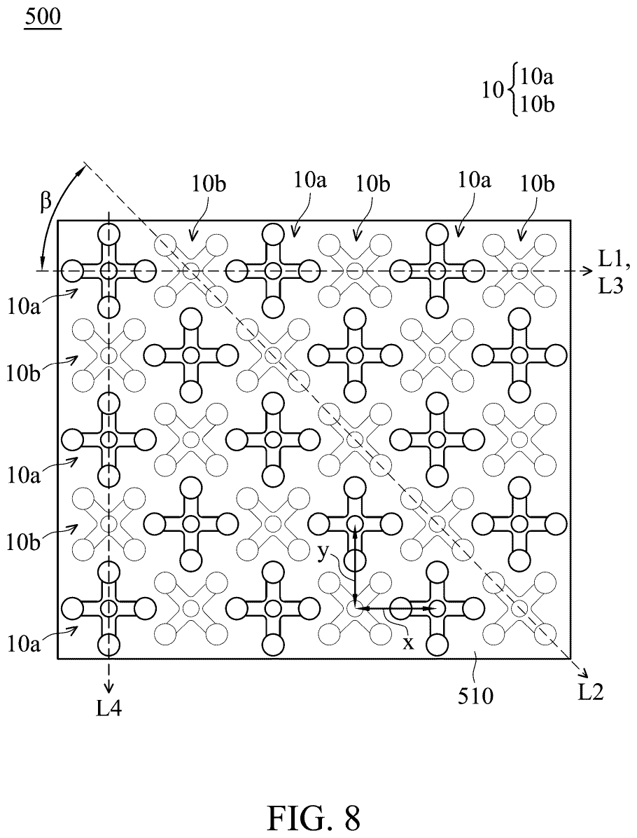

Referring to FIG. 8, according to one embodiment of the present disclosure, a lamp panel structure 500 is provided. FIG. 8 illustrates a top view of the lamp panel structure 500.

As shown in FIG. 8, the lamp panel structure 500 includes a printed circuit board (PCB) 510 and a plurality of light-emitting modules 10 as shown in FIG. 1 or a plurality of light-emitting modules 100 as shown in FIG. 7. Here, the light-emitting module 10 (its detailed structure is shown in FIG. 1) is taken as an example for illustration. The light-emitting modules 10 are disposed on the printed circuit board (PCB) 510. The light-emitting modules 10 include a plurality of first light-emitting modules 10a and a plurality of second light-emitting modules 10b. The first light-emitting modules 10a are disposed on the printed circuit board (PCB) 510 along a first direction L1. The second light-emitting modules 10b are disposed on the printed circuit board (PCB) 510 along a second direction L2. The angle β between the first direction L1 and the second direction L2 is 45 degrees. The first light-emitting modules 10a and the second light-emitting modules 10b are arranged in an alternating manner along a third direction L3 and a fourth direction L4 respectively. The third direction L3 is perpendicular to the fourth direction L4, and the first direction L1 is parallel to the third direction L3.

In some embodiments, the pitch between the first light-emitting module 10a and the second light-emitting module 10b in the third direction L3 is defined as x. The pitch between the first light-emitting module 10a and the second light-emitting module 10b in the fourth direction L4 is defined as y. The maximum length of the lens structure 14 is defined as A (the definition of the parameter is shown in FIG. 3). In some embodiments, the pitch x is approximately A±10 mm, and the pitch y is approximately A±10 mm.

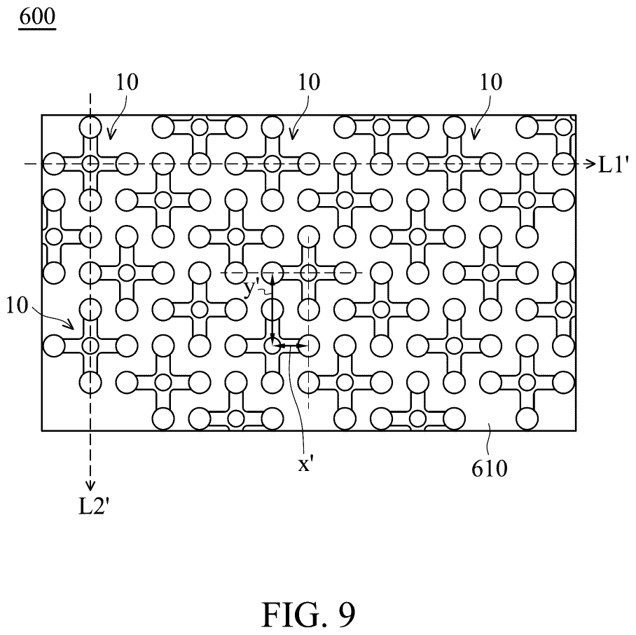

Referring to FIG. 9, according to one embodiment of the present disclosure, a lamp panel structure 600 is provided. FIG. 9 illustrates a top view of the lamp panel structure 600.

As shown in FIG. 9, the lamp panel structure 600 includes a printed circuit board (PCB) 610 and a plurality of light-emitting modules 10 as shown in FIG. 1 or a plurality of light-emitting modules 100 as shown in FIG. 7. Here, the light-emitting module 10 (its detailed structure is shown in FIG. 1) is taken as an example for illustration. The light-emitting modules 10 are disposed on the printed circuit board (PCB) 610. The light-emitting modules 10 are arranged in a staggered manner along a first direction L1′ and a second direction L2′ respectively. The first direction L1′ is perpendicular to the second direction L2′.

In some embodiments, the pitch of the light-emitting modules 10 in the first direction L1′ is defined as x′. The pitch of the light-emitting modules 10 in the second direction L2′ is defined as y′. The maximum length of the lens structure 14 is defined as A (the definition of the parameter is shown in FIG. 3). In some embodiments, the pitch x′ is approximately 0.5A±5 mm, and the pitch y′ is approximately A±5 mm.

### Example 1

The visual effect test of the disclosed single single-sided-luminescence light source with the specific lens structure

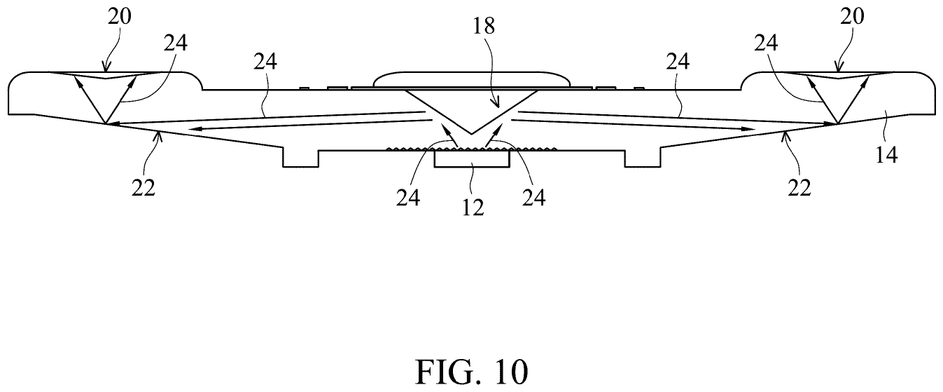

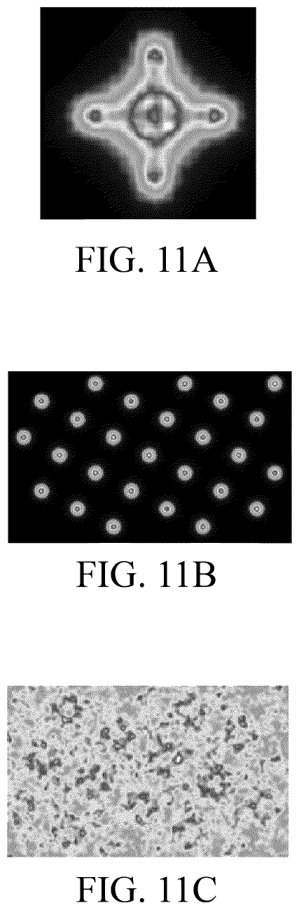

In this example, a single single-sided-luminescence light source with a specific lens structure is used for visual effect testing. First, the traveling path of light in the lens structure of this example is described with reference to FIG. 10. As shown in FIG. 10, the light source 12 emits light 24 from its upper surface. After the light 24 passes through the first recessed portion 18 in the lens structure 14, part of the light 24 moves around. The light 24 is then reflected to the second recessed portion 20 by the reflective surface 22 at the bottom of the lens structure 14 and concentrated at the second recessed portion 20 to be emitted out. The test results are shown in FIG. 11A. FIG. 11A shows that the observed light pattern has obvious cross characteristics. The central light source has a slightly bright circle feature. The brightness at the end of the cross is brighter. This shows that the visual effect of a single single-sided-luminescence light source with a lens in this example can reach the effect of five light sources.

### Comparative Example 1

The visual effect test of a light-emitting module composed of a traditional single-sided-luminescence light source without a specific lens structure

In this comparative example, a light-emitting module composed of a single-sided-luminescence light source without a specific lens structure is used for visual effect testing. The test results are shown in FIG. 11B. FIG. 11B shows that the spot light sources appear clearly on an optical surface, and the difference in light intensity therebetween is too large, resulting in obvious bright and dark areas on the optical surface (at the measurement point, the 9 points defined by the American National Standards Institute (ANSI) are adopted to obtain the average brightness).

### Example 2

The visual effect test of a light-emitting module composed of the disclosed single-sided-luminescence light source with the specific lens structure

In this example, a light-emitting module composed of a single-sided-luminescence light source with a specific lens structure is used for visual effect testing. The test results are shown in FIG. 11C. FIG. 11C shows that there is no obvious spot light source on an optical surface, and the difference in light intensity therebetween is small. The bright and dark areas cannot be clearly seen, and the uniformity is better (at the measurement point, the 9 points defined by the American National Standards Institute (ANSI) are adopted to obtain the average brightness). This shows that the disclosed light-emitting module has an improved light-expansion effect and can achieve a visually uniform effect.

### Example 3

The visual effect test of the disclosed single multiple-sided-luminescence light source with the specific lens structure

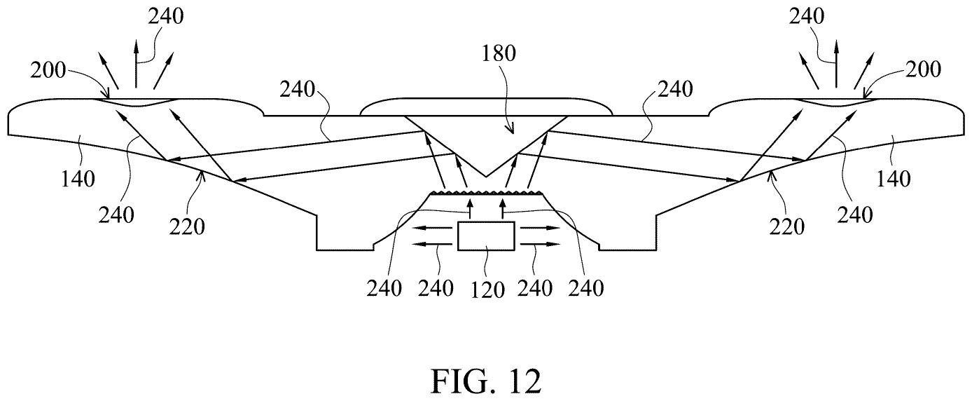

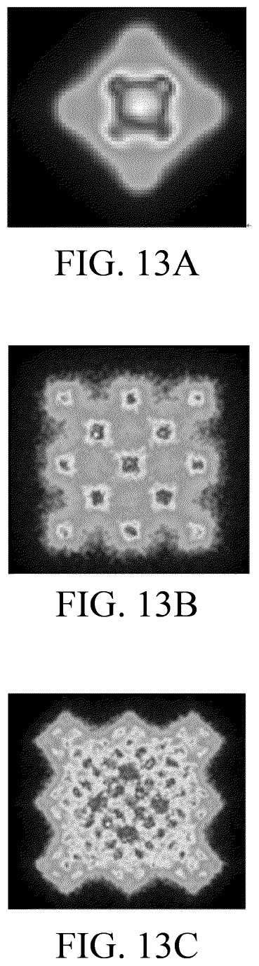

In this example, a single multiple-sided-luminescence light source with a specific lens structure is used for visual effect testing. First, the traveling path of light in the lens structure of this example is described with reference to FIG. 12. As shown in FIG. 12, the light source 120 emits light 240 from its upper surface and side surfaces. After the light 240 passes through the first recessed portion 180 in the lens structure 140, part of the light 240 moves around. The light 240 is then reflected to the second recessed portion 200 by the reflective surface 220 at the bottom of the lens structure 140 and concentrated at the second recessed portion 200 to be emitted out. The test results are shown in FIG. 13A. FIG. 13A shows that the observed light pattern resembles a rectangular light pattern, with the center being brighter and small bright spots appearing in the centers of the four sides of the rectangle. There are also slight bright spots in the four corners of the rectangle. This shows that the visual effect of a single multiple-sided-luminescence light source with a lens in this example is significantly expanded.

### Comparative Example 2

The visual effect test of a light-emitting module composed of a traditional multiple-sided-luminescence light source without a specific lens structure

In this comparative example, a light-emitting module composed of a multiple-sided-luminescence light source without a specific lens structure is used for visual effect testing. The test results are shown in FIG. 13B. FIG. 13B shows that the spot light sources appear clearly on an optical surface, and the difference in light intensity therebetween is too large, resulting in obvious bright and dark areas on the optical surface (at the measurement point, the 9 points defined by the American National Standards Institute (ANSI) are adopted to obtain the average brightness).

### Example 4

The visual effect test of a light-emitting module composed of the disclosed multiple-sided-luminescence light source with the specific lens structure

In this example, a light-emitting module composed of a multiple-sided-luminescence light source with a specific lens structure is used for visual effect testing. The test results are shown in FIG. 13C. FIG. 13C shows that the spot light sources on an optical surface are denser, the bright and dark areas cannot be clearly seen, and the uniformity is better (at the measurement point, the 9 points defined by the American National Standards Institute (ANSI) are adopted to obtain the average brightness). This shows that the disclosed light-emitting module has an improved light-expansion effect and can achieve a visually uniform effect.

In the light-emitting module of the present disclosure, after the light emitted by the light source passes through the reflective structure (for example, the first recessed portion) in the lens structure, part of the light will move around, and then the light can be emitted out from a predetermined location (for example, the second recessed portion) by the bottom design (for example, the reflective surface) of the lens structure. The present disclosure utilizes a design with a single light source with a specific lens structure (for example, a single light source with a lens structure having four second recessed portions) to achieve the luminous effect of five light sources, effectively reducing the number of required light sources.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and operations described in the specification. As one of ordinary skill in the art will readily appreciate from the disclosure of the present disclosure, processes, machines, manufacture, compositions of matter, means, methods, or operations, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or operations.

What is claimed is:

1. A light-emitting module, comprising:
a light source; and
a lens structure disposed on the light source,
wherein the lens structure has a first surface and a second surface, and the second surface is opposite to the first surface and adjacent to the light source,
wherein the first surface comprises a first recessed portion and a plurality of second recessed portions, the first recessed portion corresponds to the light source, the second recessed portions are located in an extending direction of the first recessed portion, and the second surface has a reflective surface located between the first recessed portion and the second recessed portions.

2. The light-emitting module as claimed in claim 1, wherein the first recessed portion comprises a V-shaped recessed portion.

3. The light-emitting module as claimed in claim 2, wherein the first recessed portion comprises a first reflective surface and a second reflective surface, and an angle between the first reflective surface and the second reflective surface is between 85 degrees and 130 degrees.

4. The light-emitting module as claimed in claim 1, further comprising a reflective layer disposed on the first recessed portion.

5. The light-emitting module as claimed in claim 4, wherein the reflective layer has a thickness between 0.01 mm and 0.5 mm.

6. The light-emitting module as claimed in claim 1, wherein there are two, three, or four second recessed portions.

7. The light-emitting module as claimed in claim 1, wherein each of the second recessed portions comprises a curved surface.

8. The light-emitting module as claimed in claim 7, wherein a center of the curved surface is a flat surface.

9. The light-emitting module as claimed in claim 1, wherein the second surface comprises a first area and a second area, the first area corresponds to the light source, the second area comprises the reflective surface and is adjacent to the first area, the first area comprises a flat surface, an inclined surface, or a combination thereof, and the second area comprises an inclined surface, a curved surface, or a combination thereof.

10. The light-emitting module as claimed in claim 9, wherein the first area of the second surface further comprises a third recessed portion surrounding the light source.

11. The light-emitting module as claimed in claim 1, wherein the light source comprises a single-sided-luminescence light source.

12. The light-emitting module as claimed in claim 1, wherein the light source comprises a multiple-sided-luminescence light source.

13. The light-emitting module as claimed in claim 1, wherein the light source emits white light, blue light, or ultraviolet light.

14. The light-emitting module as claimed in claim 9, further comprising a microstructure disposed on the first area of the second surface, wherein the microstructure corresponds to the light source.

15. The light-emitting module as claimed in claim 14, wherein the microstructure comprises a plurality of V-shaped structures arranged in a circular pattern, a longitudinal pattern, a transverse pattern, or a horizontally and vertically overlapping pattern.

16. The light-emitting module as claimed in claim 1, wherein the lens structure has a thickness between 2 mm and 8 mm.

17. A lamp panel structure, comprising:
a printed circuit board; and
a plurality of light-emitting modules as claimed in claim 1, disposed on the printed circuit board,
wherein the light-emitting modules comprise a plurality of first light-emitting modules and a plurality of second light-emitting modules, the first light-emitting modules are disposed on the printed circuit board along a first direction, the second light-emitting modules are disposed on the printed circuit board along a second direction, an angle between the first direction and the second direction is 45 degrees, and
wherein the first light-emitting modules and the second light-emitting modules are arranged in an alternating manner respectively along a third direction and a fourth direction, the third direction is perpendicular to the fourth direction, and the first direction is parallel to the third direction.

18. The lamp panel structure as claimed in claim 17, wherein a pitch between the first light-emitting module and the second light-emitting module in the third direction is defined as x, a pitch between the first light-emitting module and the second light-emitting module in the fourth direction is defined as y, a maximum length of the lens structure is defined as A, wherein the pitch x is A±10 mm, and the pitch y is A±10 mm.

19. A lamp panel structure, comprising:
a printed circuit board; and
a plurality of light-emitting modules as claimed in claim 1, disposed on the printed circuit board,
wherein the light-emitting modules are arranged in a staggered manner respectively along a first direction and a second direction, and the first direction is perpendicular to the second direction.

20. The lamp panel structure as claimed in claim 19, wherein a pitch of the light-emitting modules in the first direction is defined as x′, a pitch of the light-emitting modules in the second direction is defined as y′, a maximum length of the lens structure is defined as A, wherein the pitch x′ is 0.5A±5 mm, and the pitch y′ is A±5 mm.
